(19) United States
(12) Patent Application Publication
(10) Pub. No.: US 2015/0341475 A1
(43) Pub. Date: Nov. 26, 2015

(54) Phone case with built in watch

(71) Applicant: Philip Charles Johnson, Orangevale, CA (US)

(72) Inventor: Philip Charles Johnson, Orangevale, CA (US)

(21) Appl. No.: 14/120,473

(22) Filed: May 23, 2014

(51) Int. Cl. H04M 1/02; H04B 1/3888; H04M 1/22; G04B 37/12

(52) U.S. Cl. CPC H04M 1/026; G04B 37/12; H04B 1/3888; H04M 1/22

(57) ABSTRACT

A phone case with built in watch with a rectilinear phone retaining protective case including four side panels fixedly attached to a base panel, a watch member, a watch retaining member and a transparent panel member. The base panel includes a recessed portion capable of removably retaining the watch member. The watch retaining member covers the watch member and has a central aperture to allow the watch to be viewed. The transparent panel member covers the watch face. A preferred embodiment includes the watch retaining member having outwardly extending tabs which engage with apertures in the base panel allowing the watch retaining member to be held in place by rotating the watch retaining member ninety degrees.

### CROSS REFERENCE TO RELATED APPLICATIONS

Provisional patent 61/959,097 filed Aug. 15, 2013

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of smart phone covers and more specifically to a phone case with built in watch.

Smart phone protective cases are well known. They usually include a base panel and four attached side walls with cutouts in the walls to allow for key components of the phone to be accessed, such as the on/off button and the cable connecting receptacles. The two elongate side walls include a small overhang that allows the phone cover to snap onto the top edge of the phone, thereby retaining it.

Most smart phones have a time display feature that can be seen when the phone is turned on. However, the time and effort needed to actually turn on the phone and read the display is problematic for some people. Therefore it would be an advantage to have a time display that can be seen on the outer surface of the phone case thereby eliminating the need to turn on the phone to check the time.

Additionally, some people like to decorate the outside surface of their phone case. Currently, the only way to decorate the outside of the case is to purchase a case that has decorations affixed to it. However, this does not allow a person to customize or easily change the graphics on the outside of the case without removing and changing the entire case. It would be helpful to have a phone case where a graphic panel can be applied and can be easily removed and replaced when so desired.

### BRIEF SUMMARY OF THE INVENTION

The primary object of the invention is to provide a phone case for protecting a smart phone which has a watch built into the underside of the case so that a person can check the time without needing to turn on their phone.

Another object of the invention is to provide a phone case with built in watch where the watch can be removed from the case when necessary.

Another object of the invention is to provide a phone case with a built in watch where the transparent cover of the watch is flush with the outer surface of the case.

A further object of the invention is to provide a phone case with a built in watch where the area surrounding the watch can be decorated with a graphic panel.

Yet another object of the invention is to provide a phone case with a built in watch where the entire surface of the back of the case is covered with a transparent protective panel.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed phone case with built in watch comprising: a rectilinear phone retaining protective case including four side panels fixedly attached to a base panel, a watch member, a watch retaining member, a transparent panel member, said base panel including a recessed portion capable of removably retaining said watch member, said watch retaining member covering said watch member and having a central aperture to allow said watch to be viewed, and said transparent panel member covering said watch face.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is an exploded view of the invention.

FIG. 3 is a section view of the invention.

FIG. 4 is an exploded view of the transparent cover and graphic panel

FIG. 5 is an exploded view of a graphic panel to be placed over the base plate of the phone case.

FIG. 6 is a perspective view of a first alternate embodiment of the invention.

FIG. 7 is an exploded view of the first alternate embodiment of the invention.

FIG. 8 is an exploded view of a second alternate embodiment where the clear cover continues down the sides of the case.

FIG. 9 is a side view of the second alternate embodiment of the invention.

FIG. 10 is a perspective view of a third alternate embodiment of the invention that includes an LED light and switch.

FIG. 11 is a side view of the second alternate embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

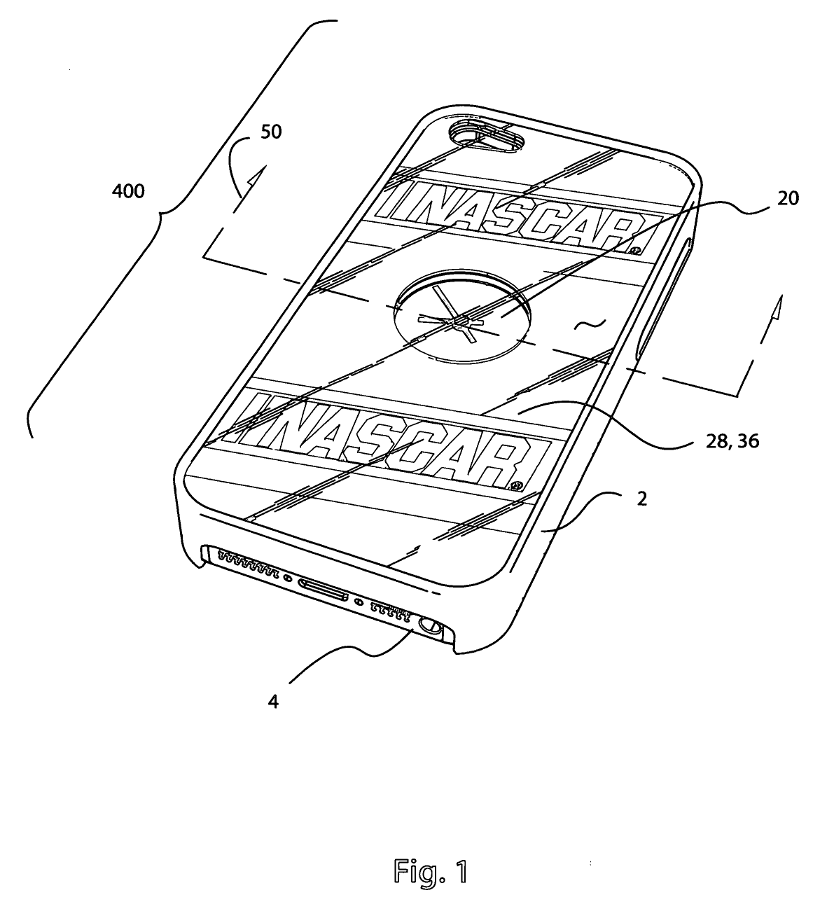

Referring now to FIG. 1 we see a perspective view of the invention 100 holding a smart phone 4. The main case 2 is similar to conventional smart phone cases in that it has a main base plate and four side walls. The side walls include cut out portions to allow the user to have access to the phone's features such as on/off and electrical connector socket. However, the base plate of the present invention 100 is thicker than a standard smart phone case and includes a depressed area that holds a watch movement and watch faceplate 20. In the preferred embodiment, the watch movement is a quarts analogue type movement, however other watch movements can be used including digital movements and wind up movements. A transparent cover plate 20 is flush with the top portion of the phone housing 2. A graphics panel 36 is situated just under transparent panel 28 and includes a cut out aperture that corresponds with the location of watch faceplate 20. In one embodiment, the watch face graphic cover 20.

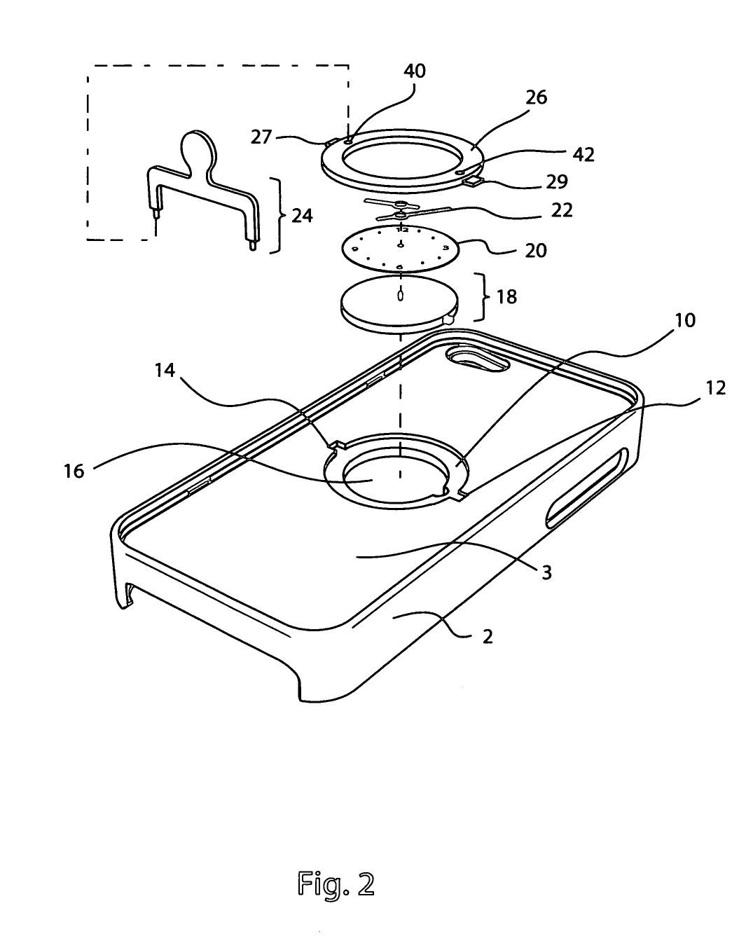

FIG. 2 shows an exploded view of the watch portion of the invention as it relates to the main case 2. A watch movement 18 can be inserted into depressed area 16. A custom graphic faceplate 20 can be added to the top of the watch movement 18. Watch retaining cover 26 includes tabs 27, 29 which insert into cut out areas 12, 14. The retaining cover 26 can be turned by inserting the tips of tool 24 into apertures 40, 42 located on the cover 26 as shown in FIG. 2. The retaining cover 26 sits in depression 10 so that it is flush with the top portion of base plate 3.

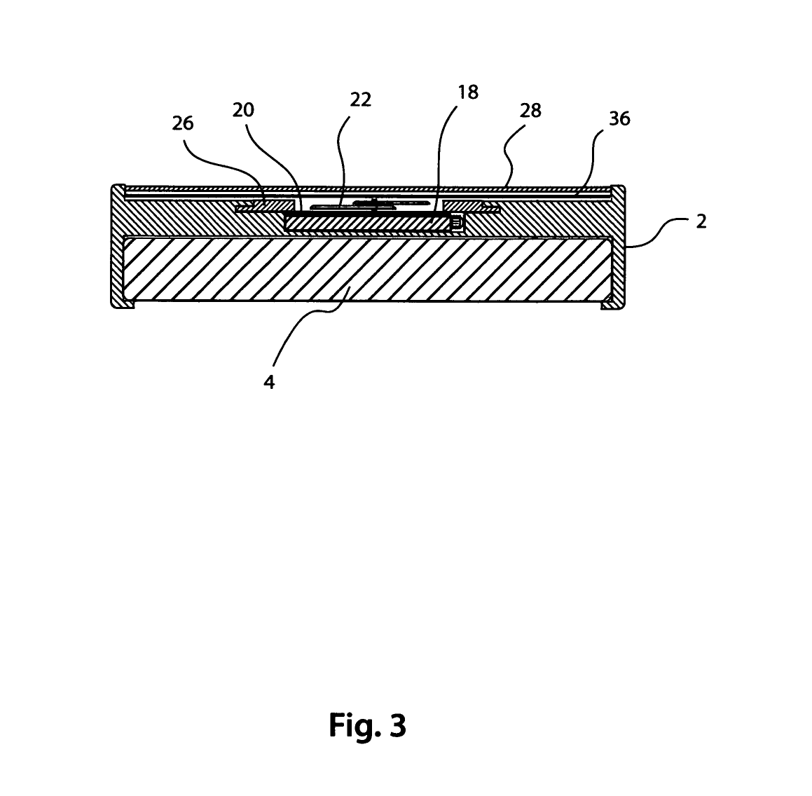

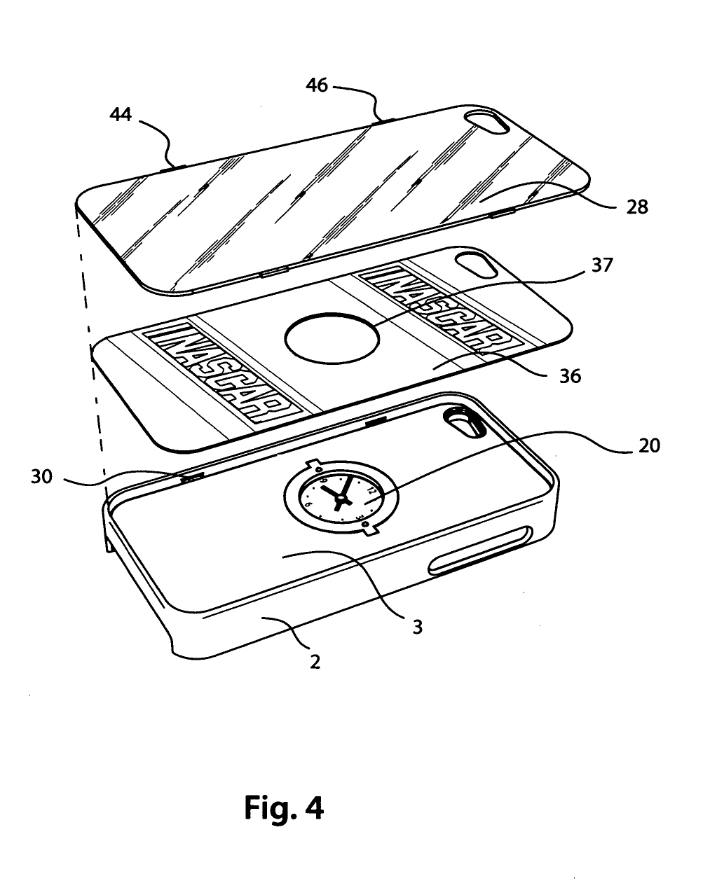

FIG. 3 shows a section view of the invention that bisects the invention as shown by section line 50 in FIG. 1. Main housing 2 can be seen holding smart phone 4. Watch movement 18 is located in the deepest recess 16. Retaining cover 26 can be seen holding the watch movement 18 in place. Graphic panel 36 is placed over the watch assembly as will be described in FIG. 4. Transparent cover plate 28 is located in depressed area in the main housing 2 so that it is flush with the top of the main housing 2.

FIG. 4 shows an exploded view of the main housing 2 with the watch 18, watch face 20 and retaining cover 26 in place. A graphic panel 36 with cut out aperture 37 can be placed onto base plate 3 so that the aperture 37 is aligned with the watch face 20. Decorative graphics can be printed on the panel 36. The panel 36 can also be used for advertising purposes. Transparent cover plate 28 is placed over graphic panel 36 and held in place by tabs 44, 46 being inserted into cut out portions 28, 30.

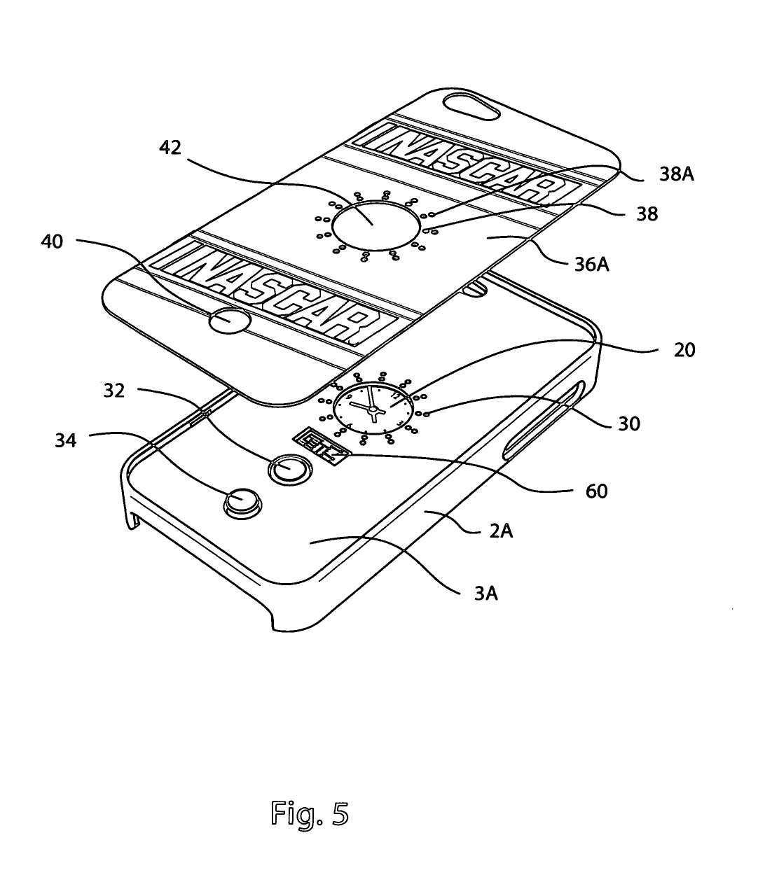

FIG. 5 shows a second embodiment of the invention where LEDs 38, 38A are located just outside of the watch face 20 on base plate 2A. A microprocessor circuit 60 interacts with contacts on the watch movement so that when a person pushes button 40 on graphic panel 36A a switch 34 embedded in base plate 3A causes the corresponding LEDs, 38 for minute hand and 38A for hour hand, to become illuminated thereby allowing the user to see the time in a dark environment. Battery 32 powers the LEDs 38, 38A and the microprocessor circuit 60. Alternately, LEDs can be used to illuminate the watch face 20, which can be seen through aperture 42 on graphic panel 36A, without using perimeter LEDs 38, 38A. Other electronic features can be added to the invention in a similar fashion. These include electronic timer and alarm features.

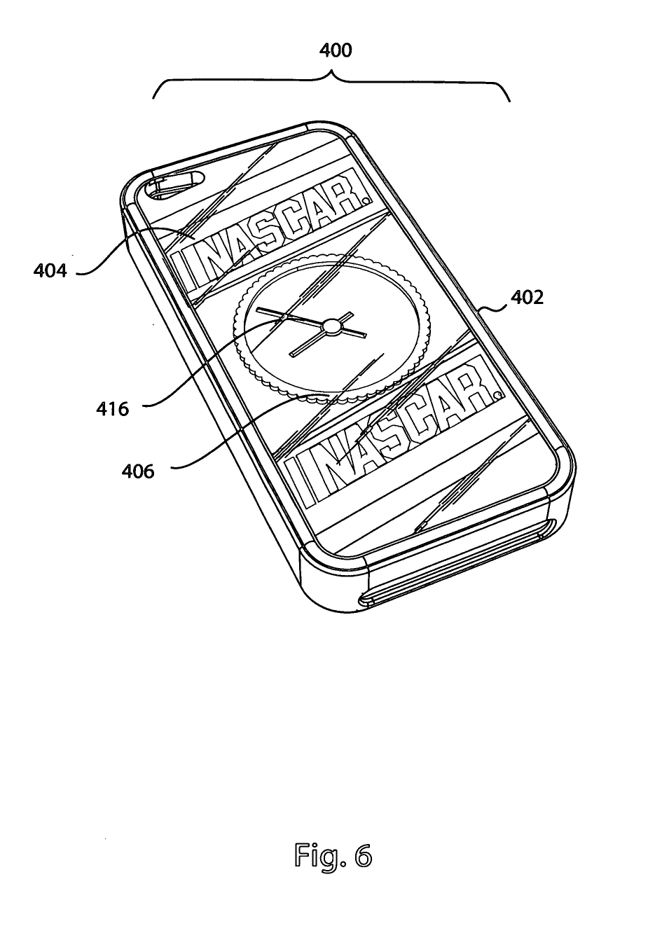

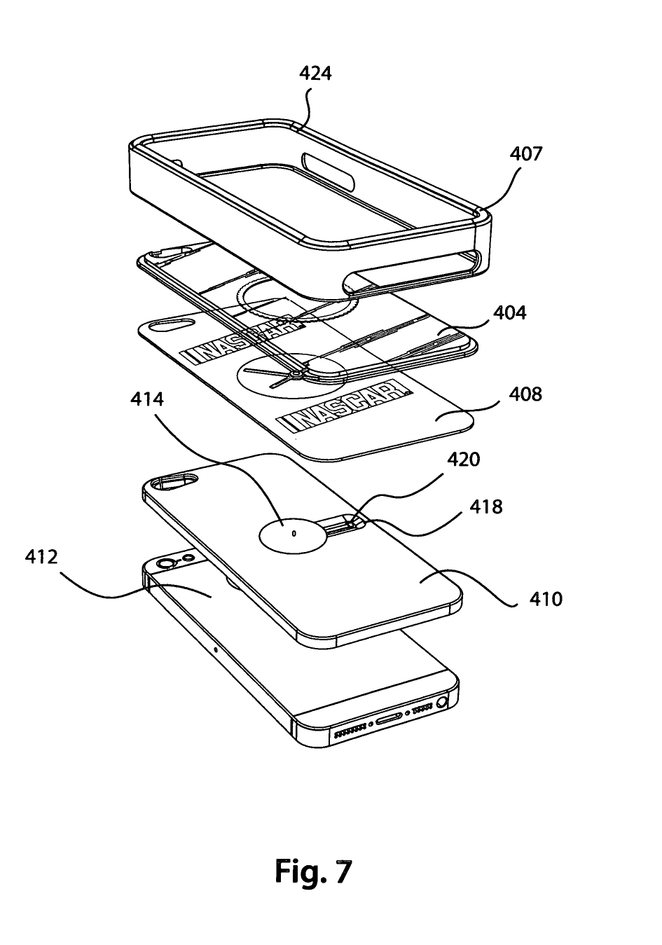

FIG. 6 shows a first alternate embodiment of the invention 400. Clear cover 404 includes a downward facing circular ring 406 that insures that the cover 404 does not hit the watch hands 416. The exploded view of first alternate embodiment 400 is shown in FIG. 7. Surround piece 402 retains clear cover panel 404, graphic panel 408, mid panel 410 and smart phone 412. Watch hands 416 are mounted to watch member 414 before clear panel 404 is added. The cutout area 418 of mid panel 410 allows the watch mechanism 414 including time adjustment stem 420 to be secured in place. The center post of watch member 414 extends up through an aperture in graphic panel 408 and watch hands 416 are attached to the center post. A top lip 424 retains the clear panel 404 and a return ledge 422 retains the underside of the phone 412 thereby creating a secure sandwich effect that holds all the panels in place.

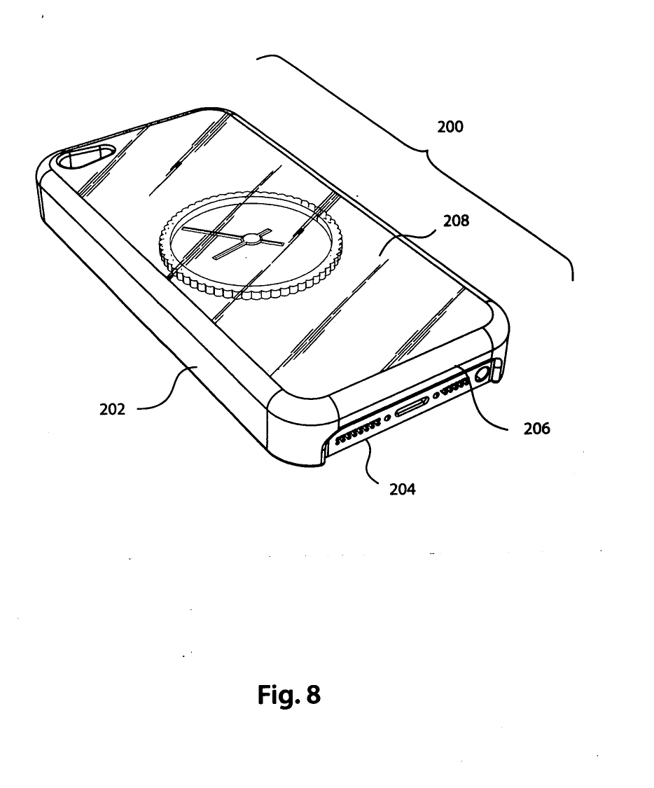

FIG. 8 is a second alternate embodiment of the invention 200 where the clear top panel 208 and the side panels 202 are integrated into one unit thereby making for a simpler and less expensive construction. Additionally, the use of a clear side panel 202 reduces the visual thickness of the unit 200 because a person sees the graphic panel and tends to not see the height of the sides 202 of the clear panel.

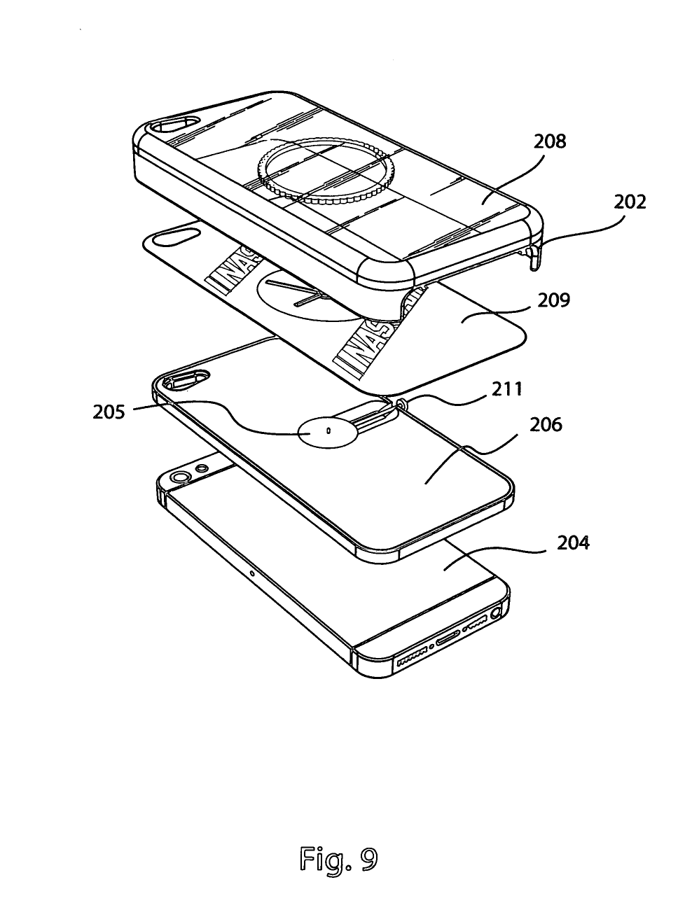

FIG. 9 is an exploded view of the second alternate embodiment 200. Transparent cover 208 includes side walls 202 that trap watch holding panel 206, graphic panel 209 and phone 204. This embodiment eliminates the need for a separate surround member as shown in the first embodiment. The watch stem 211 extends out from watch member 205 and beyond the outer surface of clear transparent side panel 207 so that the user can set the time without having to remove the transparent top panel 208. A slit 213 in the side wall of panel 202 allows the user to install the transparent cover 208 after the watch 205 and watch stem 211 have been installed in the watch holding panel 206.

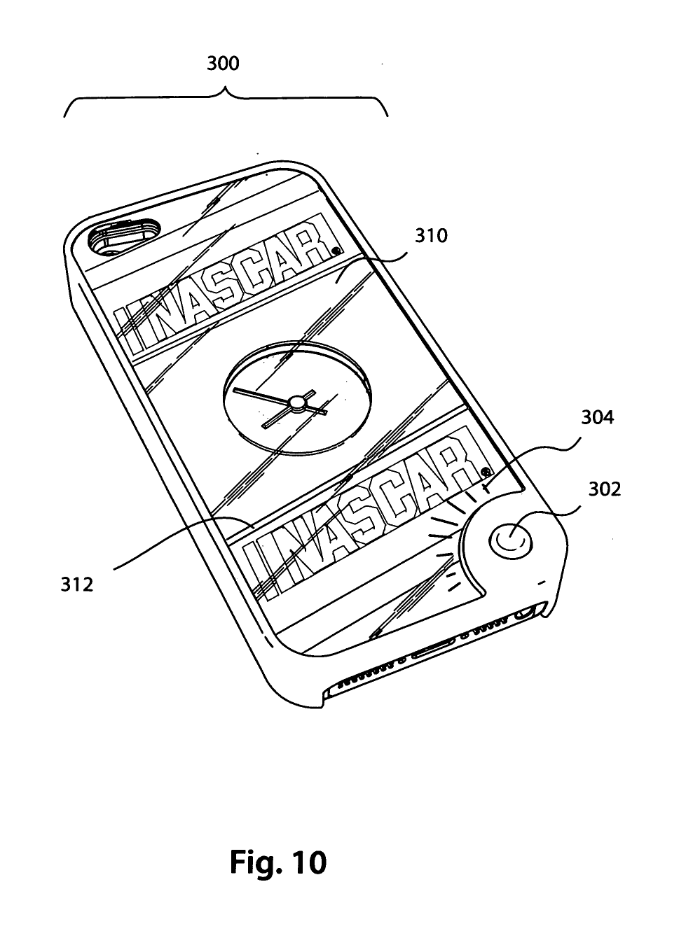

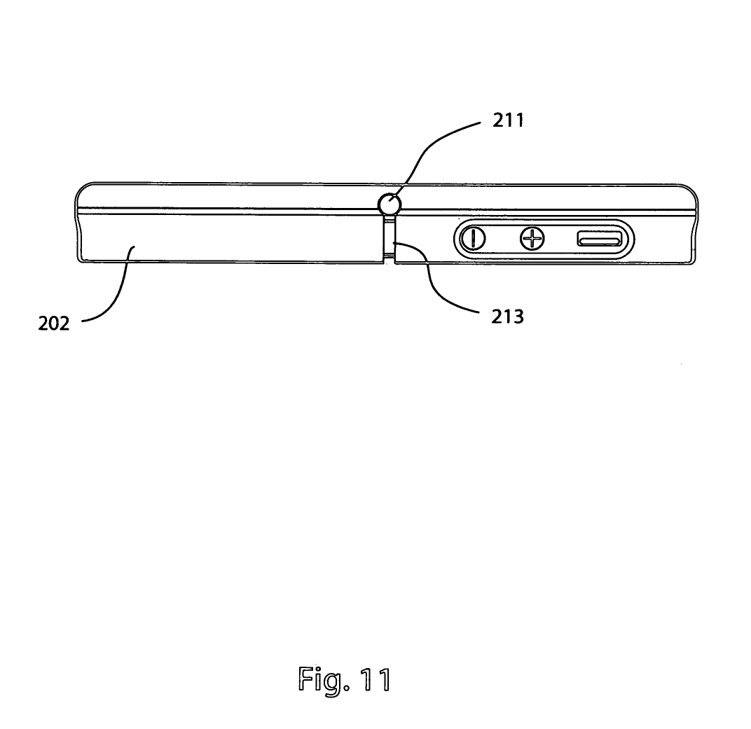

FIG. 10 is a perspective view of a third alternate embodiment 300. FIG. 11 is a side section view of the third alternate embodiment where one or more LEDs 306, a battery power supply 314 and a switch 308 are incorporated into the space between the transparent cover 310 and the graphic panel 312. The switch can be a 308 can be a standard pushbutton type switch or can be a capacitance type switch where the user touches a spot 302 on the outer surface of the case 300 and causes the LED light to turn on for a specific length of time as determined by a standard timer circuit, not shown.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. a phone case with built in watch comprising:
a rectilinear phone retaining protective case including four side panels fixedly attached to a base panel;
a watch member;
a watch retaining member;
a transparent panel member;
said base panel including a recessed portion capable of removably retaining said watch member;
said watch retaining member covering said watch member and having a central aperture to allow said watch to be viewed; and
said transparent panel member covering said watch face and is flush with the top surface of said base panel.

2. A phone case with built in watch as claimed in claim 1 wherein said watch retaining member includes outwardly extending tabs which engage with apertures in said base panel allowing said watch retaining member to be held in place by rotating said watch retaining member ninety degrees.

3. A phone case with built in watch as claimed in claim 1 wherein said transparent panel member includes outwardly extending tabs that can engage apertures in said base panel to cause said transparent panel to remain in place and cover said watch member.

4. A phone case with built in watch as claimed in claim 1 further comprising a graphic panel that can be trapped between the outside of said base panel and the underside of said transparent panel.

5. A phone case with built in watch as claimed in claim 4 wherein an alternate embodiment said graphic panel acts as the said watch retaining member.

6. A phone case with built in watch as claimed in claim 1 wherein a downwardly facing cylindrical ring is fixedly attached to the underside of said transparent panel and acts as a spacer for insuring that the hands of said watch do not touch said graphic panel.

7. A phone case with built in watch as claimed in claim 1 wherein an alternate embodiment said transparent panel and said rectilinear phone retaining case are incorporated into one molded transparent part rather than two separate parts.

8. A phone case with built in watch as claimed in claim 6 wherein one or more LEDs and a battery power supply are included in the space between said transparent panel and said graphic panel and are used for illuminating said watch when a person activates a switch on the outside of said transparent panel.

9. A phone case with built in watch as claimed in claim 8 wherein said switch is a capacitance switch mounted on said transparent panel.
